(19) United States
(12) Patent Application Publication
(10) Pub. No.: US 2009/0300543 A1
(43) Pub. Date: Dec. 3, 2009

(54) VISUAL INDICATION OF CHANGES IN THE SAME USER INTERFACE DIALOG ORIGINALLY USED TO ENTER THE DATA

(76) Inventors: Carl Steven Mower, Sunnyvale, CA (US); Matthew Alan Palmer, Menlo Park, CA (US)

Correspondence Address: PILLSBURY WINTHROP SHAW PITTMAN LLP, P.O. BOX 10500, MCLEAN, VA, 22102, US

(21) Appl. No.: 12/357,066

(22) Filed: Jan. 21, 2009

Related U.S. Application Data
(60) Provisional application No. 61/021,887, filed on Jan. 17, 2008.

(51) Int. Cl. G06F 3/048

(52) U.S. Cl. 715/809

(57) ABSTRACT

A method for generating a graphical display denoting a difference between values from different invocations of dialog boxes in a graphical user interface comprising: displaying a dialog box on a display device; detecting a value that has changed in the dialog box; and displaying a previous value corresponding to the detected value; wherein the previous value is displayed in front of the dialog box, adjacent to, but not overlapping, the detected value. The previous value may be displayed with the same format as the corresponding detected value. Further information may be displayed along with the previous value, including the version number of the user interface and the name of the editor. Differences from one version of the dialog box to the next, one version to another, between multiple editing sessions, and within a current editing session may be displayed. A portion of the dialog box may be changed, by highlighting for example, to indicate a difference exists between current and previous values.

### CROSS-REFERENCE TO RELATED APPLICATIONS

This application claims the benefit of U.S. Provisional Application Ser. No. 61/021,887, filed Jan. 17, 2008, which is expressly incorporated by reference herein.

### BACKGROUND

1. Field of the Invention

The present invention relates generally to graphical user interfaces, and more specifically to visual indications of changes made to the screens of the user interface.

2. Description of the Related Art

Many Graphical User Interface (GUI) software systems contain numerous complex screens containing “dialog boxes”. While, if designed well, GUIs can present the multitude of questions/options to the user in a clear and easy to understand way, there has been no convenient way to indicate to the user what values may have been changed on previous invocations of that dialog. Today's conventional solutions often resort to textual descriptions of the values modified in a dialog box in a previous editing session. Unfortunately, such textual representations are not what the user may be familiar with, since the representation of the change is presented in a different format to the entries on the GUI screen. For example, Cisco and Juniper routers offer networking devices that have embedded Web pages (UI) that export the device's configuration as a plain-text configuration file. The user needs to correlate the textual descriptions of what changed with the GUI elements that the user would actually use to make such changes. This forces the user to learn two “languages”—that of the GUI and that of the textual output of changes. There is a need for more readily understandable ways to provide visual representations of changes made to a GUI screen.

### SUMMARY OF THE INVENTION

The concepts and methods of embodiments of the present invention allow a clear visual indication of changes that have been made in a user interface dialog box by displaying the differences in front of the same user interface dialog box. Embodiments of the present invention may be used to display differences in any versioned graphical user interface and may be used for configurations of almost anything, including networking devices, software components on a server, or any other complex system that has a GUI for configuring its settings.

According to aspects of the invention, a method for generating a graphical display denoting a difference between values from different invocations of dialog boxes in a graphical user interface comprises: displaying a dialog box on a display device; detecting a value that has changed in the dialog box; and displaying a previous value corresponding to the detected value; wherein the previous value is displayed in front of the dialog box, adjacent to, but not overlapping, the detected value. The previous value may be displayed with the same format as the corresponding detected value. Further information may be displayed along with the previous value, including the version number of the user interface and the name of the editor. Differences from one version of the dialog box to the next, one version to another, between multiple editing sessions, and within a current editing session may be displayed. A portion of the dialog box may be changed, by highlighting for example, to indicate a difference exists between current and previous values.

According to further aspects of the invention, a graphical user interface of a computer program stored on a computer-readable medium comprises: a graphical display denoting a difference between values from different invocations of a dialog box in the graphical user interface; wherein the previous value is displayed in front of the dialog box, adjacent to, but not overlapping, the detected value.

### BRIEF DESCRIPTION OF THE FIGURES

These and other aspects and features of the present invention will become apparent to those ordinarily skilled in the art upon review of the following description of specific embodiments of the invention in conjunction with the accompanying figure, wherein:

FIG. 1 shows an illustration of a GUI screen with clear indications of changes, according to embodiments of the invention.

### DETAILED DESCRIPTION

Embodiments of the present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Many Graphical User Interface (GUI) software systems contain numerous complex screens containing “dialog boxes”. Dialog boxes are used to present questions/options to a user in a clear and easy to understand way. It is very often useful for the user to be able to see what values may have been changed on previous invocations of that dialog. The term “difference” is used to denote a difference between one set of UI values and another. Being able to see a difference is particularly useful on UI screens for displaying/editing configuration settings. These screens are preferably designed with sufficient space to show a graphical display of a difference.

The dialog boxes and graphical displays of differences are displayed on a display device for a user to view. A computer device is connected to the display device. The computer device may be part of a computer network. A pointing device, such as a mouse, is integrated with the computer device so as to allow the user to move a cursor on the screen of the display device and to interact with the dialog boxes. Computer programs for (1) generating GUIs with dialog boxes and (2) generating graphical displays of differences are available to the computer device on computer-readable media, such as a computer disc, hard drive, floppy, memory chip, etc. The programs for the generation of the GUIs and the graphical displays of the differences may be separate or combined. Values from previous and current versions of dialog boxes are stored in computer memory, typically in databases, accessible to the computer device for generation of the differences. The hardware configurations described above are for networking devices. However, the present invention is not limited to these configurations. The present invention may be used for configurations of almost anything, including networking devices, software components on a server, or any other complex system that has a GUI for configuring its settings. Note that the present invention includes a methodology implemented in software, for which any general-purpose computer with a graphical interface will suffice for the implementation.

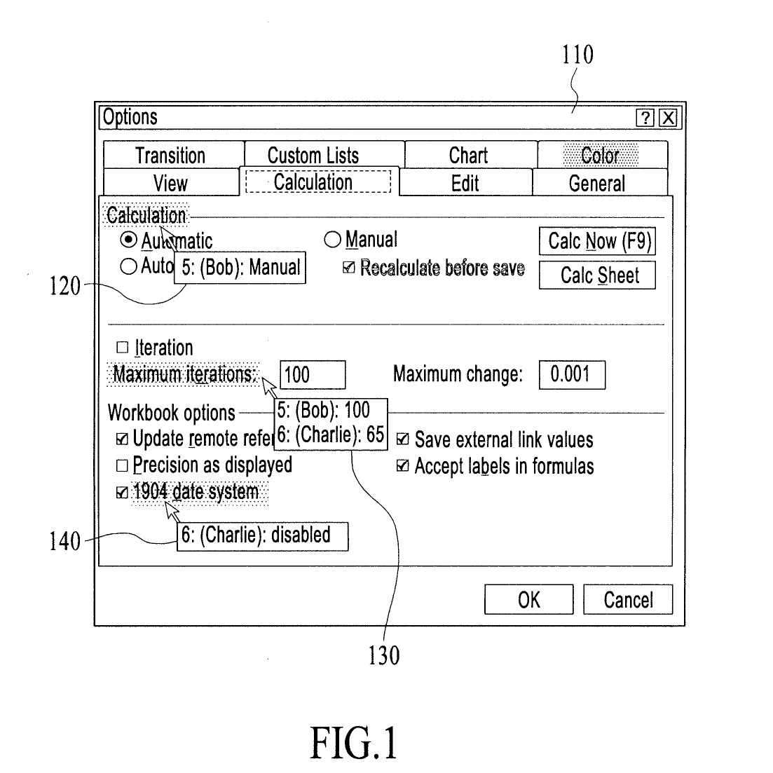

There are many ways in which differences can be shown in a UI screen. FIG. 1 shows an example of a UI screen 110 with differences 120, 130 and 140, according to embodiments of the invention. The radio buttons, check boxes, text/number entry boxes and drop-down menus, otherwise known as widgets, on the screen 110 show the current/most recent values. However, when the user moves their cursor to a widget, or executes a “mouseover,” the previous value(s) for that widget are shown. The previous values will disappear when the cursor is moved off the widget. The cursor is shown as a pointer in FIG. 1. Use of mouseover is especially appropriate as the user only sees the differences if they ask for them by moving their mouse, and yet the user doesn't have to move to another screen. The graphical displays of the differences present the changed values in the same format as the values in the dialog boxes—this presentation is readily understandable and familiar to the user of the dialog boxes. Furthermore, the graphical displays of the differences are positioned on the UI screen adjacent to, but not obscuring, the current value for which the difference has been generated. FIG. 1 shows the result of 3 mouseovers in the same screen capture image, where the user is performing a difference across several versions, in this example from v5 to v7, where v7 is the current version. Note that only one difference is shown at once; three differences are shown in FIG. 1 for the purposes of illustration alone. The dialog boxes show all the v7 values, and highlights any value that differs among the versions: v5, v6, & v7. Note that instead of highlighting the differences, one could use a different color font, bolding, or other mechanisms that draw the user's attention to the widget. The highlighted items in FIG. 1 are “Calculation,” “Maximum iterations,” and “1904 date system,” which are all on the “Calculation” tab. Note that the “Color” tab is also highlighted, indicating changes under that particular tab. When the user mouseovers a highlighted item, the mouseover may show: (1) all the prior, different, values of that widget over the selected range of versions; (2) the version ID; and (3) the user that made the change. For example, difference 120 indicates that the radio button was set to “Manual” by Bob in v5, which is different to the “Automatic” setting selected by the current user in v7. Difference 130 indicates that the “maximum iterations” was set to 100 by Bob in v5, changed to 65 by Charlie in v6 and has been changed to 100 by the current user in v7. Note that the v5 and v6 values are arranged in a column, so as to make it easier for the user to observe the changes. Difference 140 indicates that “1904 date system” was disabled by Charlie in v6 and then enabled by the current user in v7. Note that in these examples it is assumed there is only one user editing v7; if there are multiple users, differences can be generated to show the contributions of the different editors.

According to embodiments of the invention, the GUI screens have a “next difference”/“previous difference” button/link, as well as a “show differences”/“hide differences” alternating button/link. Buttons/links are also provided to present a list of all the revisions of the entity and some input values allowing the user to select the versions to compare. These buttons/links are not shown in FIG. 1.

Graphical displays of differences may be used in a variety of circumstances, such as: (1) to show what changed for a user who has been tasked with approving a revision; (2) to show what changed from one version to the next; (3) to show what changed from one version to another; (4) to show “round-trip” differences; (5) to show users what they have changed as they edit. In describing these uses of differences, examples are provided within the context of revision of networking device configurations. However, the present invention is not limited to networking applications. Any software system that uses GUI components to enter/edit settings that need to be version controlled will benefit from embodiments of the present invention.

A significant part of the workflow of many network managers is to review and approve networking device config changes before they are deployed to the network. The graphical display of differences to show what has been changed, according to embodiments of the present invention, makes this task significantly easier.

A graphical display of a difference may be used to show what changed from one version to the next. For example each ‘slice’ of a master template for networking device configuration can have many versions, each of which are retained. When reviewing this history users will want to see what changed from one version to the next. This difference-option can show changes from all versions, or from a selected range of consecutive versions. The selection of versions may be made using a difference menu.

A graphical display of a difference may be used to show what changed from one version to another. The user can select from a menu to compare any particular versions that are of interest, where the versions need not be consecutive. This difference-option can show changes from multiple edit sessions by multiple users. For example, one could difference version 14 with version 24, even though several different people may have made the 10 sets of changes.

A graphical display of a difference may be used to show “round-trips.” This use of a difference changes how versions are counted. For example, take a drop-down that selects a 802.11 channel from options 1-11. It could be that channel 6 was selected in v3, changed by Alice to channel 11 in v4, and changed back to channel 6 by Bob in v5. Ordinarily there would be no net difference from v3 to v5 for this particular widget. However, with round-trip difference enabled, this difference-option would show the “round-trip” history—the change from channel 6 to channel 11 and then back to channel 6.

A graphical display of a difference may be used to show a user as they edit what they have changed. As the user edits a config, for example, the difference function may be used to review the changes before hitting “save” or “submit”. This difference-option may be activated by mouseover, as described above, or a button/link may be provided to display the changes.

In the difference-options described above, the graphical display of the differences will include the following information, when relevant: (1) all the prior, different, values of that widget over the selected range of versions; (2) the version indicator; and (3) the user that made the change. Note that all three items of information are provided for the examples shown in FIG. 1. However, the version indicator and the user are extraneous, and need not be displayed, when displaying a difference for: the purpose of approving changes; a simple difference between adjacent versions; and live editing. Furthermore, the graphical display of the differences may also include information such as the time and date of a change, etc.

Typically, different versions of an entity are stored in a database. The differences programs retrieve values for the relevant version(s) and compare the retrieved values with current values to detect differences. Once a difference is detected, the user is alerted by highlighting the relevant widgets, or equivalent, as described above. The same general method applies to detecting differences in a current editing session.

Differences may also be selected based on date and/or time. For example, instead of selecting a version directly, the user may select a particular date and time and the program will determine the appropriate version for which to generate a difference. Furthermore, a time period may be used as a selection criteria for a difference. For example, the user selects a time period, with beginning and ending date/time and the program will determine the appropriate version(s) for which to generate a difference.

Furthermore, differences may also be selected based on the name of the person who made the changes. For example, the user could request the program to generate differences to show all changes made by a particular person.

Although the present invention has been particularly described with reference to embodiments thereof, it should be readily apparent to those of ordinary skill in the art that changes and modifications in the form and details may be made without departing from the spirit and scope of the invention. It is intended that the appended claims encompass such changes and modifications. The following claims define the present invention.

What is claimed is:

1. A method for generating a graphical display denoting a difference between values from different invocations of dialog boxes in a graphical user interface, said method comprising:
displaying a dialog box on a display device using a computer;
detecting a value that has changed in said dialog box using said computer, said computer being coupled to said display device; and
displaying a previous value corresponding to said value on said display device using said computer;
wherein said previous value is displayed on said display device in front of said dialog box, adjacent to, but not overlapping, said value.

2. A method as in claim 1, wherein said previous value is displayed with the same format as the corresponding value.

3. A method as in claim 1, further comprising collecting from computer memory values for a previous version of said dialog box.

4. A method as in claim 1, wherein said detecting is detecting changes from one version of said dialog box to the next.

5. A method as in claim 1, wherein said detecting is detecting changes from one version of said dialog box to another.

6. A method as in claim 5, wherein said displaying further comprises displaying the version number corresponding to said previous value.

7. A method as in claim 1, wherein said detecting is detecting changes in a current editing of said dialog box.

8. A method as in claim 1, wherein said detecting is detecting changes between multiple editing sessions of said dialog box.

9. A method as in claim 1, further comprising changing a portion of said dialog box to indicate said value.

10. A method as in claim 9, wherein said changing is highlighting.

11. A method as in claim 9, wherein said displaying is in response to selecting the changed portion.

12. A method as in claim 9, wherein said displaying is in response to moving a cursor over the changed portion.

13. A method as in claim 1, wherein said displaying further comprises displaying the user responsible for entering said previous value.

14. A computer-readable medium storing a program for generating a graphical display denoting a difference between values from different versions of dialog boxes in a graphical user interface, said program causing a computer to perform:
displaying a dialog box on a display device;
detecting a value that has changed in said dialog box; and
displaying a previous value corresponding to said value;
wherein said previous value is displayed in front of said dialog box, adjacent to, but not overlapping, said value.

15. A system for generating a graphical display denoting a difference between values from different versions of dialog boxes in a graphical user interface, said system comprising:
a computer-readable memory medium storing a computer program, said computer program including instructions for:
displaying a dialog box on a display device;
detecting a value that has changed in said dialog box; and
displaying a previous value corresponding to said value;
wherein said previous value is displayed in front of said dialog box, adjacent to, but not overlapping, said value.

16. A graphical user interface of a computer program stored on a computer-readable medium, said graphical user interface comprising:
a graphical display denoting a difference between values from different invocations of a dialog box in said graphical user interface;
wherein said previous value is displayed in front of said dialog box, adjacent to, but not overlapping, said value.

17. A graphical user interface as in claim 16, wherein said graphical display displays a value from a previous invocation of said dialog box.

18. A graphical user interface as in claim 17, wherein the value in said graphical display has the same format as the value in said dialog box.
